(19) United States
(12) Patent Application Publication
(10) Pub. No.: US 2023/0166574 A1
(43) Pub. Date: Jun. 1, 2023

(54) Extended Travel Air Spring

(71) Applicant: Wheel Pros, LLC, Greenwood Village, CO (US)

(72) Inventors: Reno Heon, San Luis Obispo, CA (US); Dustin Heon, Arroyo Grande, CA (US)

(73) Assignee: Wheel Pros, LLC, Greenwood Village, CO (US)

(21) Appl. No.: 17/902,976

(22) Filed: Sep. 5, 2022

Related U.S. Application Data
(60) Provisional application No. 63/241,044, filed on Sep. 6, 2021.

(51) Int. Cl. B60G 11/46

(52) U.S. Cl. CPC B60G 11/465; B60G 2202/152; B60G 2204/43; B60G 2204/126

(57) ABSTRACT

A “Rolling Lobe” style of air spring with an extendable piston increases the overall travel of the air spring without increasing the compressed height of the spring.

### BACKGROUND OF THE INVENTION

Field of the invention: This invention relates to the general field of suspension for vehicles, and more particularly to novel technology relating to manufacturing of efficient and effective “Rolling Lobe” style of air spring with an extendable piston, where the invention increases the overall travel of the air spring without increasing the compressed height of the spring.

Background of the invention: Vehicles generally come with leaf-spring suspension, which consists of one or more bent pieces of metal that rest the vehicle frame on the axle and absorb a lot of the rough ride experienced by the tires. Some vehicles have a combination of leaf-spring (mechanical) suspension and air suspension. One of the more popular types of air springs is the “rolling lobe” air spring, which has a piston in a bellow that allows the air spring to expand in a vertical direction - called “vertical travel”. However, the current rolling lobe air springs require that to get more vertical travel, the manufacturer must make new air springs with taller bellows and pistons. This invention solves the problem by providing an extendible piston that increases the over vertical travel without the need to increase the compressed height of the air spring.

Problem Described: Air suspension is a desired complement to traditional leaf spring suspension in many vehicles. However, the compressed height of the air spring can present problems in terms of finding enough space to mount the air spring as an air spring with substantial vertical travel must be manufactured quite tall. Since there is limited space between a vehicle frame and a leaf spring, this inherently limits the size of the air spring that can be installed, and therefore, also limits the vertical travel, thereby providing an amount of air suspension that is not ideal.

Summary of Invention: The invention is a rolling lobe type of air spring, but with an extendable piston that allows a smaller compressed air spring to provide vertical travel that is superior to the existing products on the market today.

Advantages over Products Currently on the Market. The invention as described in this provisional application allows extra extension of an air spring while maintaining a minimal compressed height. The provides a number of commercial advantages over products currently on the market. First, the extra extension provides additional vehicle suspension vertical travel. The prior art has shown that limiting a vehicle’s suspension travel with an air spring is too short can cause poor suspension performance and damage the air spring. Second, the invention provides an air spring that maintains a low compressed height. This increases the vertical travel of the suspension without increasing the compressed height of the spring allows the spring to fit into tight vehicle suspension packages. Third, the invention allows for efficient rotation of air springs. As can be seen by products currently on the market, the rolling lobe air spring can be damaged if too much torsional forceis applied to it. The extendable piston design also works as a rotating mechanism to prevent any torsion experienced by the suspension to be translated into the air spring.

Prior Art. The prior art provides the current state-of-the-art in installable air springs.

For example, US 7497423 discloses an extendable end member for a gas spring assembly that appears similar to this invention, but requires a flexible wall placed under tension between the end member and a second piston member. Without the need for either of these components, the current invention provides superior extension in a more efficient package.

US 6905113 discloses a double rolling-lobe spring arrangement, which has an extension device located in the center of the air spring. This invention requires more seals and moving parts that the current invention, and is therefore more expensive, more difficult to manufacture, and more prone to breakage.

The prior art also provides WO2019232383, which claims an air spring system for a heavy-duty vehicle, which contains a bellows connected to a mountain bracket by a retention collar. However, this product, like the previously-listed patent, has multiple moving parts inside the body of the air spring, making access and repair difficult, and as with any mechanical device, the more parts it has -particularly moving parts - the more likely it is to break.

There has thus been outlined, rather broadly, the more important features of the invention in order that the detailed description thereof may be better understood, and in order that the present contribution to the art may be better appreciated. There are additional features of the invention that will be described hereinafter and which will form the subject matter of the claims appended hereto. The features listed herein and other features, aspects and advantages of the present invention will become better understood with reference to the following description and appended claims. The accompanying drawings, which are incorporated in and constitute part of this specification, illustrate embodiments of the invention and, together with the description, serve to explain the principles of the invention.

It should be understood the while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

### BRIEF DESCRIPTION OF THE FIGURES

One preferred form of the invention will now be described with reference to the accompanying drawings.

FIG. 1 is a perspective view of a prior art air spring.

FIG. 2 is a front view of a prior art air spring at several stages of vertical extension.

FIG. 3 is a front, cut-away view of the air spring that is the subject of this patent application.

FIG. 4 is a perspective, cut-away view of the air spring with the piston in both collapsed and extended positions.

### DETAILED DESCRIPTION OF THE FIGURES

The present invention is a uniquely designed extendable piston assembly, utilizing unique and effective/efficient technologies to create an air spring with improved vertical travel in a package small enough to be installed in a wide variety of vehicles. The various advantages provided by this invention are described more fully with respect to the drawings that have been provided.

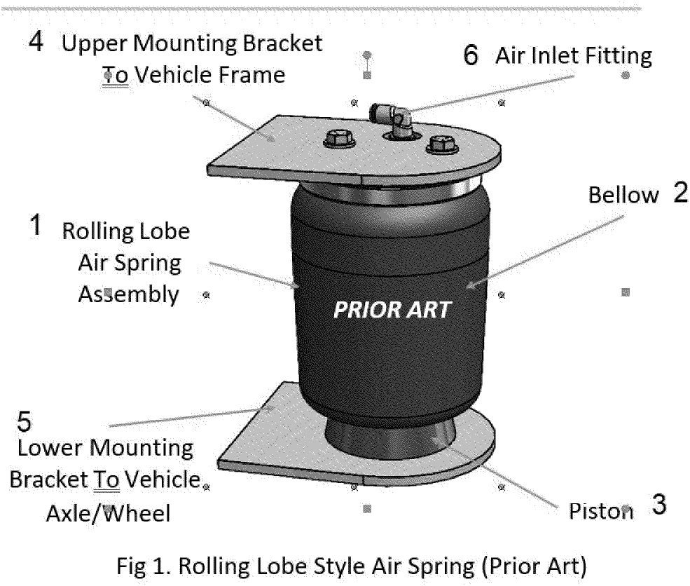

FIG. 1 is a perspective view of a prior art air spring. The Air Spring Assembly 1 is mounted between a vehicle frame and a leaf spring through, an Upper Mounting Bracket 4 and a Lower Mounting Bracket 5. The Air Spring Assembly 1 comprises a Bellow portion 2 and a Piston portion 1. When compressed air is added through the Air Inlet Fitting 6, the Bellow 2 rises out of the Piston 3, creating a volume of compressed air that cushions the ride of the vehicle.

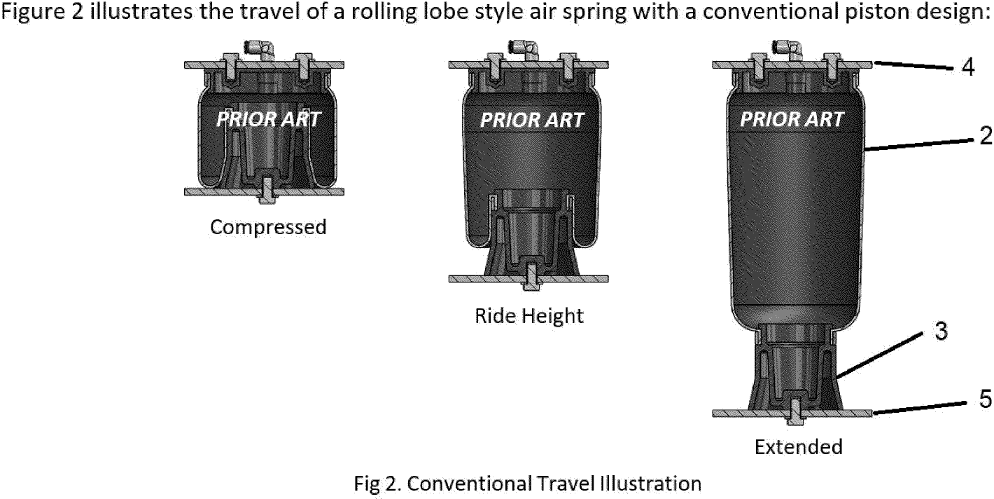

FIG. 2 is a front view of a prior art air spring at several stages of vertical extension. The air spring is initially installed in a Compressed state, the compressed air is added to cause the air spring to vertically expand to a Ride Height. When additional vertical height is desired, more compressed air is added and the air spring develops into an Extended Height.

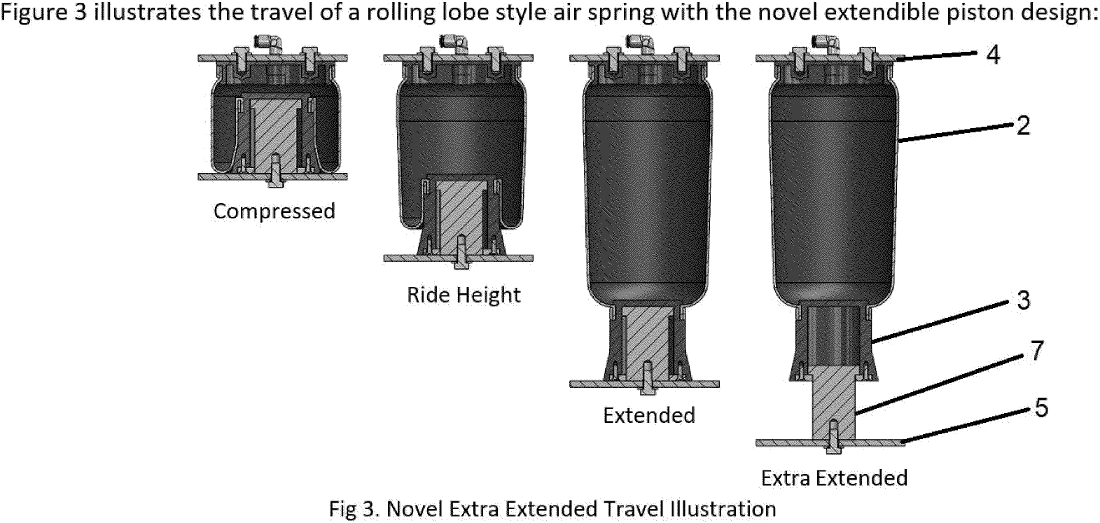

FIG. 3 is a front, cut-away view of the air spring that is the subject of this patent application. In addition to the Compressed, Ride Height, and Extended vertical heights shown in the prior art of FIG. 2, with the current invention the Extendable Piston Portion 7 allows for a substantially greater vertical extension of the air spring. This allows for the same Compressed stage as shown the prior art of FIG. 2 and the current invention of FIG. 3 to be easily installed, but the Extendable Piston Portion 7 allows for an even greater vertical travel.

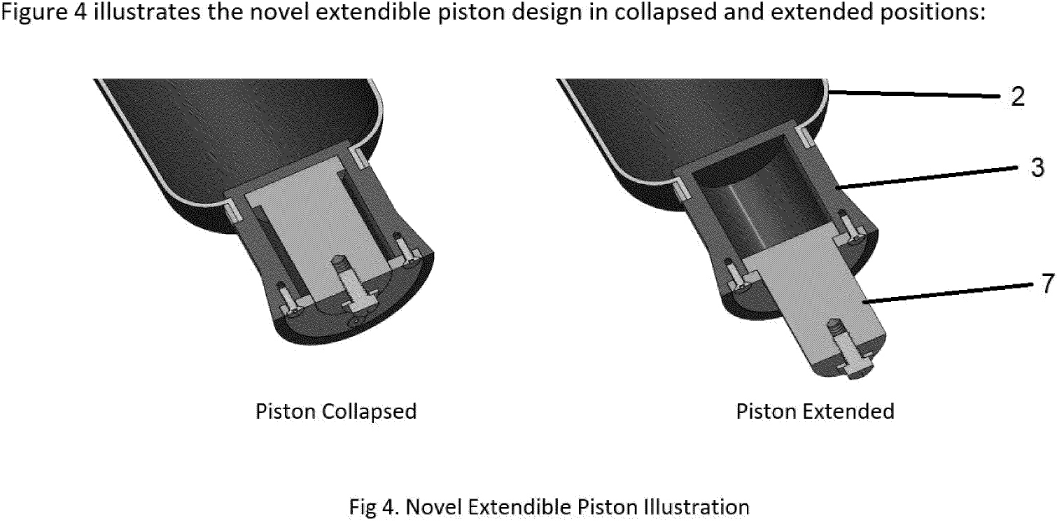

FIG. 4 is a perspective, cut-away view of the air spring with the piston in both collapsed and extended positions. The Extendable Piston Portion 7 is telescopically enclosed in the Piston, such that it can be extended to provide greater vertical travel.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention.

Many aspects of the invention can be better understood with references made to the drawings as attached. The components in the drawings are not necessarily drawn to scale. Instead, emphasis is placed upon clearly illustrating the components of the present invention. Moreover, like reference numerals designate corresponding parts through the several views in the drawings. Before explaining at least one embodiment of the invention, it is to be understood that the embodiments of the invention are not limited in their application to the details of construction and to the arrangement of the components set forth in the following description or illustrated in the drawings. The embodiments of the invention are capable of being practiced and carried out in various ways. In addition, the phraseology and terminology employed herein are for the purpose of description and should not be regarded as limiting.

It should be understood that while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

Reference Numbers Used

| | |
|---|---|
| 1. | Air Spring |
| 2. | Bellow |
| 3. | Piston |
| 4. | Upper Mounting Bracket |
| 5. | Lower Mounting Bracket |
| 6. | Air Inlet Fitting |
| 7. | Extendable Piston Portion |

What I claim is:

1. A device for providing air suspension to a vehicle consisting of, an air spring, an upper mounting bracket, a lower mounting bracket, and an air inlet fitting, where the air spring comprises a bellow, a piston, and an extendable piston portion, where the upper mounting bracket attaches to a vehicle frame, and where the lower mounting bracket attaches to a leaf spring, and where the piston is telescopically encased within the bellow, and where the extendable piston portion retractably extends below the piston to provide an extra amount of vertical travel to the air spring, and where the air spring has a compressed position, a ride height position, an extended position, and an extra extended position, and where the compressed position has a compressed position height, and where the extra extended position has an extra extended position height, and there the extra extended position height is at least twice as high as the compressed position height.

2. A device for providing air suspension to a vehicle comprising, an air spring, an upper mounting bracket, a lower mounting bracket, and an air inlet fitting, where the air spring comprises a bellow, a piston, and an extendable piston portion, where the upper mounting bracket attaches to a vehicle frame, and where the lower mounting bracket attaches to a leaf spring, and where the piston is telescopically encased within the bellow, and where the extendable piston portion retractably extends below the piston to provide an extra amount of vertical travel to the air spring.

3. The device of claim 2, where the air spring has a compressed position, a ride height position, an extended position, and an extra extended position.

4. The device of claim 3, where when the air spring is in the compressed position a bottom of the bellow touches a top surface of the lower mounting bracket.

5. The device of claim 4, where when the air spring is in the ride height position the bottom of the bellow is above the top surface of the mounting bracket but below a top of the piston, and a piston bottom at a bottom of the piston is touching the top surface of the mounting bracket.

6. The device of claim 5, where when the air spring is in the extended position, the bottom of the bellow is at the top of the piston, and the piston bottom is touching the top surface of the mounting bracket.

7. The device of claim 6, where when the air spring is in the extra extended position the bottom of the bellow is at the top of the piston, and the piston bottom is above the top surface of the mounting bracket.

8. The device of claim 7, where the piston bottom is retained by an extendable piston portion upper lip, and where the compressed position has a compressed position height, and where the extra extended position has an extra extended position height, and there the extra extended position height is at least twice as high as the compressed position height.

9. A device for providing air suspension to a vehicle consisting of an air spring, an upper mounting bracket, a lower mounting bracket, and an air inlet fitting.

10. The device of claim 9, where the air spring comprises a bellow, a piston, and an extendable piston portion, where the upper mounting bracket attaches to a vehicle frame/.

11. The device of claim 10, where the lower mounting bracket attaches to a leaf spring.

12. The device of claim 11, where the piston is telescopically encased within the bellow.

13. The device of claim 12, where the extendable piston portion retractably extends below the piston to provide an extra amount of vertical travel to the air spring.

14. The device of claim 13, where the air spring has a compressed position, a ride height position, and extended position, and an extra extended position.

15. The device of claim 14, where when the air spring is in the compressed position a bottom of the bellow touches a top surface of the lower mounting bracket.

16. The device of claim 15, where when the air spring is in the ride height position the bottom of the bellow is above the top surface of the mounting bracket but below a top of the piston, and a piston bottom at a bottom of the piston is touching the top surface of the mounting bracket.

17. The device of claim 16, where when the air spring is in the extended position, the bottom of the bellow is at the top of the piston, and the piston bottom is touching the top surface of the mounting bracket.

18. The device of claim 17, where when the air spring is in the extra extended position the bottom of the bellow is at the top of the piston, and the piston bottom is above the top surface of the mounting bracket.

19. The device of claim 18, where the piston bottom is retained by an extendable piston portion upper lip.

20. The device of claim 19, where the compressed position has a compressed position height, and where the extra extended position has an extra extended position height, and there the extra extended position height is at least twice as high as the compressed position height.
